(19) United States
(12) Patent Application Publication
(10) Pub. No.: US 2025/0223524 A1
(43) Pub. Date: Jul. 10, 2025

(54) METHOD FOR MANUFACTURING A DETERGENT PORTION UNIT

(71) Applicant: HENKEL AG & CO. KGAA, Düsseldorf (DE)

(72) Inventors: Matthias SUNDER, Düsseldorf (DE); Friedhelm SIEPMANN, Essen (DE); Lena KOEGEL, Krefeld (DE)

(21) Appl. No.: 18/854,020

(22) PCT Filed: Jan. 18, 2023
(86) PCT No.: PCT/EP2023/051055

§ 371 Date: Oct. 3, 2024

(30) Foreign Application Priority Data
Apr. 13, 2022 (DE) 10 2022 203 706.5

(51) Int. Cl. C11D 11/00; C11D 3/20; C11D 17/00

(52) U.S. Cl. CPC C11D 11/0094; C11D 3/2096; C11D 17/003

(57) ABSTRACT

A method for manufacturing a detergent portion unit including a dimensionally stable solid gel is described. The method includes mixing first and second free-flowing compositions using a dynamic mixer such that a surfactant-containing and gelling agent-containing mixture is formed. The surfactant-containing and gelling agent-containing mixture is introduced into a shaping device and maintained to solidify such that a dimensionally stable solid gel is formed.

The present invention relates to a method for manufacturing a detergent portion unit, comprising a solid gel.

Continuously changing requirements are placed on the forms of manufacture and supply of washing and cleaning agents. The main focus has, for quite some time, been on the convenient dosing of detergents and cleaning agents by the consumer and the simplification of the work steps necessary for carrying out a washing or cleaning method. One technical solution is provided by pre-portioned washing or cleaning agents, for example, water-soluble containers having one or more receiving compartments for powdered or liquid detergents or cleaning agents. A further technical solution is provided by detergent tablets which can have a single-phase or multi-phase design.

To produce the water-soluble containers, water-soluble polymers are generally deformed to form receiving chambers, which are subsequently filled with a detergent or cleaning agent and finally closed. The receiving chambers can be produced, for example, from water-soluble polymer films by means of deep-drawing methods. In an alternative embodiment of the method, a water-soluble polymer is deformed by means of injection molding to form a receptacle.

The water-soluble packaging material used for packaging the filled detergent portion units is generally hygroscopic. In the context of the production, packaging, storage, and subsequent use by the consumer, the water absorption tendency and water absorption capacity of the packaging means can cause the portion units to adhere to surfaces of machines or packaging means and not be able to be conveyed optimally, or adjacent portion units, e.g., in a common outer packaging, to adhere to one another. To avoid this adhesion tendency of the water-soluble portion units, it is possible to modify the surface properties thereof by applying a powder agent. The powdering of the water-soluble detergent portion units in turn requires an additional method step.

The water-soluble packaging materials used are generally not washing active or cleaning active, i.e., do not contribute to the product performance. The reduction in the amount of packaging with respect to the total weight of the detergent portion units would thus not result in loss of performance and would be welcomed on the grounds of sustainability and economic efficiency.

Finally, the washing performance provided by the detergent portion unit is directly related to the dissolution properties of the portion unit. Particularly with regard to the increasing use of cold washing methods, it is preferred to keep the thickness of the water-soluble film material contained in the detergent portion unit as low as possible in order to accelerate the dissolution process. However, the reduction in the thickness of the surrounding film material simultaneously requires a reduced mechanical stability of the portion units. Overcoming this apparent dichotomy of mechanical stability and dissolution rate of detergent portion units packaged using water-soluble films is still a relevant aspect in the development of water-soluble detergent portion units.

Detergent tablets, in which, however, sufficient mechanical stability and a high dissolution rate are irreconcilably opposed in a similar manner as in the case of the sachets, offer an alternative to the previously described sachets.

Multi-phase detergent portion units, for example in the form of core tablets, which in addition to a tableted body comprise wax or gel phases, offer an alternative to completely compressed detergent tablets. Thus, European patent EP 1 032 642 B1 describes, for example, detergent tablets comprising a compressed phase and an uncompressed gel phase and a method for the manufacturing thereof.

Against the background of the prior art described above, the object of the application was that of providing efficient methods for manufacturing fast-dissolving detergent portion units that have high product and storage stability, can be packaged in a simple manner using minimal amounts of additional packaging materials, and appeal to the consumer based on an attractive olfactory, visual, and/or tactile experience. The detergent portion units should have a high product performance and be easy and safe to handle for the consumer.

A first subject matter of the application is a method for producing a detergent portion unit, comprising
a) a dimensionally stable solid gel, the method comprising the steps of:
   i) providing a first free-flowing surfactant-containing composition;
   ii) providing a second free-flowing gelling agent-containing composition that is different from the first free-flowing composition;
   iii) continuously feeding the first and second free-flowing compositions to a dynamic mixer;
   iv) mixing the first and second free-flowing compositions by means of the dynamic mixer such that a surfactant-containing and gelling agent-containing mixture is formed;
   v) introducing the surfactant-containing and gelling agent-containing mixture into a shaping device;
   vi) letting the surfactant-containing and gelling agent-containing mixture solidify such that a dimensionally stable solid gel is formed.

The term “detergent portion unit” describes a supply form in which a measured portion of a detergent or cleaning agent is present. Detergent portion units consequently refer both to supply forms for textile laundry and to supply forms for cleaning hard surfaces such as ceramics, glass, metal, or tiles. The detergent portion unit preferably has a weight of 14 g to 42 g, preferably of 18 g to 38 g, in particular of 20 g to 34 g.

The detergent portion unit comprises a solid gel. The detergent portion unit can consist of the solid gel. In this case, the solid gel preferably has a weight of 14 g to 42 g, more preferably of 18 g to 38 g, in particular of 20 g to 34 g. If the detergent portion unit comprises further constituents in addition to the solid gel, the weight of the solid gel is preferably 10 g to 28 g, preferably 12 g to 23 g and in particular 15 g to 20 g

Bodies which exhibit elastic deformation behavior under the action of force are referred to as gel bodies. Bodies are considered dimensionally stable if they have an inherent dimensional stability that enables them to assume a non-disintegrating three-dimensional shape under the usual conditions of manufacture, storage, transport and handling by the consumer, this three-dimensional shape also not changing under the conditions mentioned over an extended period of time, preferably 4 weeks, particularly preferably 8 weeks and in particular 32 weeks, i.e., under the usual conditions of manufacture, storage, transport and handling by the consumer, the body remains in the three-dimensional geometric shape created during manufacture, i.e., it does not dissolve.

The three-dimensional shape of the solid gel is basically freely selectable; its side surfaces can, for example, be designed to be convex, concave or planar. At the same time, however, certain spatial configurations have proven to be particularly advantageous against the background of the manufacturability, storage, and use of the solid gels.

In correspondingly advantageous detergent portion units, the solid gel comprises a flat underside, the largest diagonal of which is greater than the height of the solid gel. Not only can these bodies be manufactured in a simple manner, for example by means of casting methods, but they can also be packaged in a simple and space-saving manner and are suitable for dosing via the dosing or dispensing chambers of electronic cleaning devices. It is particularly preferred if the solid gel has a flat underside, the largest diagonal of which is more than 1.5 times, preferably more than twice the height of the solid gel.

For manufacturability, for example in relation to the removal of the solid gel from a casting mold, it has proven to be advantageous if the underside of the solid gel does not have any corners. Preferred solid gels are therefore characterized by oval undersides or alternatively by ellipsoidal or round, preferably round, undersides. Corresponding solid gels with non-angular undersides are also preferred by many consumers due to their optics. For example, such solid gels having an underside and an upper side which are connected to one another by a cylindrical lateral surface are therefore preferred.

Advantages in relation to the use of space during manufacture and packaging are realized by angular undersides. If the solid gels are molded, for example, in the form of plates, which are subsequently cut into solid gels, angular undersides are advantageous since such solid gels can be cut without any residual amounts occurring and can be packaged in a space-saving manner. In an alternative embodiment, preferred solid gels therefore have angular undersides, in particular triangular, square or hexagonal undersides. For further processing or packaging, it can be advantageous if the solid gel has an angular underside with rounded corners.

With regard to the manufacture, packaging, and use of the detergent portion units, it has also proven to be advantageous if the solid gels have an upper side plane parallel to the underside.

In a first preferred geometric embodiment, the solid gel has an underside and an upper side which have the same geometric shape, wherein the underside and the upper side have the same surface size. As already described above, corresponding solid gels can be produced in a simple manner, for example by casting plates and subsequently cutting the plates into individual solid gels. In addition, in any subsequent method steps, said solid gels can be spatially aligned during packaging or use by the user due to the geometric identity of the underside and upper side as solid gels with reduced body symmetry. This applies in particular to solid gels which at the same time have an upper side plane parallel to the underside. Examples of such solid gels are circular cylinders, elliptical cylinders, parallelepipeds, rhomboids, straight or oblique prisms, cuboids or cubes. The group of circular cylinders and elliptical cylinders in turn includes vertical circular cylinders and elliptical cylinders as well as the inclined circular cylinders and elliptical cylinders. Due to their simple production by isolation from a plate, solid gels in the form of vertical circular cylinders, vertical elliptical cylinders, straight prisms, straight cuboids or cubes are preferred.

In an alternative embodiment, the solid gel has an underside and an upper side which have the same geometric shape, wherein the underside and the upper side have different surface sizes. Corresponding solid gels can be preferred due to their attractive appearance or their optimized fit while simultaneously being comparatively simple to manufacture. Examples of such solid gels include circular cylinders or elliptical cylinders with a convex or concave underside and a planar upper side. Further examples include truncated cones or truncated pyramids.

In summary, preferred subject matters of the application can be characterized as detergent portion units comprising a solid gel having an underside and an upper side, wherein the surface of the upper side amounts to 80 to 100%, preferably 90 to 100%, and in particular 98 to 100% of the underside.

The method is particularly suitable for the packaging of solid gel having a high surfactant content. In preferred embodiments, the first free-flowing surfactant-containing composition contains, based on the total weight thereof, 30 to 70 wt. %, preferably 40 to 60 wt. % and in particular 45 to 55 wt. % surfactant.

In terms of the manufacturability and the subsequent dissolving power of the solid gels, it has proven advantageous for them to contain 15 to 35 wt. %, preferably 20 to 30 wt. %, of an aqueous-organic solvent. The aqueous-organic solvent of the solid gel is preferably introduced via the first and second free-flowing compositions. Thus, it is preferred if the second free-flowing gelling agent-containing composition further contains an organic solvent. Particularly preferred free-flowing gelling agent-containing compositions contain gelling agents and organic solvents in a total weight proportion above 50 wt. %, preferably above 70 wt. % and in particular above 90 wt. %.

Preferred solid gels further contain dye.

Preferred solid gels are transparent. Such solid gels are referred to as “transparent” if they have a transmission above 50%, preferably above 60% and in particular above 80%, in the wavelength range of from 410 to 800 nm at at least one wavelength, preferably at 600 nm. The transmission is determined by means of VIS spectrometry at a sample temperature of 20° C. and a cuvette length of 10 mm.

For the manufacture and later storage and transport properties of the solid gels, it has proven advantageous to use low-molecular-weight gelling agents having a molar mass of up to 2000 g/mol in the solid gel, wherein the weight proportion thereof with respect to the total weight of the solid gel is preferably less than 5 wt. %, preferably 0.1 to 5 wt. %, and particularly preferably 0.1 to 2.5 wt. %. Furthermore, the advantages of the method according to the invention are particularly evident in the processing of these low-molecular-weight gelling agents with their specific gelling properties.

In a preferred embodiment, the low-molecular-weight gelling agent has a solubility in water of less than 0.1 g/L (20° C.). The solubility of the organic gelator compound is determined at 20° C. in bidistilled, demineralized water.

Furthermore, gelling agents are preferably suitable which comprise a structure containing at least one hydrocarbon structural unit having 6 to 20 carbon atoms (preferably at least one carbocyclic, aromatic structural unit) and additionally an organic structural unit that is covalently bonded to the aforementioned hydrocarbon unit and has at least two groups selected from —OH, —NH—, or mixtures thereof.

Particularly preferred solid gels are characterized in that said solid gels contain at least one benzylidene alditol compound of formula (GB-I) as gelling agent

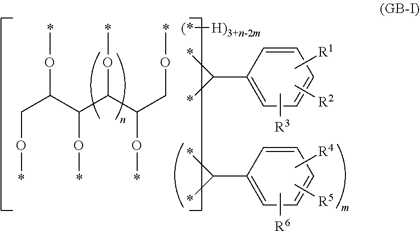

wherein
*— represents a covalent single bond between an oxygen atom of the alditol backbone and the provided functional group,
n represents 0 or 1, preferably 1,
m represents 0 or 1, preferably 1,
R¹, R² and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵ and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, an —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring.

Due to the stereochemistry of the alditols, it should be mentioned that said benzylidene alditols according to the invention are suitable in the L configuration or in the D configuration or in a mixture of the two. Due to natural availability, the benzylidene alditol compounds are preferably used according to the invention in the D configuration. It has proven preferable if the alditol backbone of the benzylidene alditol compound according to formula (GB-I) contained in the shaped body is derived from D-glucitol, D-mannitol, D-arabinitol, D-ribitol, D-xylitol, L-glucitol, L-mannitol, L-arabinitol, L-ribitol or L-xylitol.

Particularly preferred are those solid gels which are characterized in that R¹, R², R³, R⁴, R⁵ and R⁶ according to the benzylidene alditol compound of formula (GB-I) mean, independently of one another, a hydrogen atom, methyl, ethyl, chlorine, fluorine, or methoxy, preferably a hydrogen atom.

n according to the benzylidene alditol compound of formula (GB-I) preferably represents 1.

m according to the benzylidene alditol compound of formula (GB-I) preferably represents 1.

The solid gel very particularly preferably contains at least one compound of formula (GB-11) as the benzylidene alditol compound of formula (GB-I)

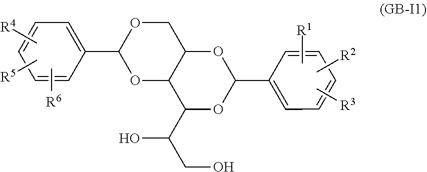

where R¹, R², R³, R⁴, R⁵ and R⁶ are as defined in formula (I). Most preferably, according to formula (GB-11), R¹, R², R³, R⁴, R⁵ and R⁶ represent, independently of one another, a hydrogen atom, methyl, ethyl, chlorine, fluorine, or methoxy, preferably a hydrogen atom.

Most preferably, the benzylidene alditol compound of formula (GB-I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol or mixtures thereof.

Preferred solid gels contain at least one 2,5-diketopiperazine compound of formula (GB-II) as the gelling agent

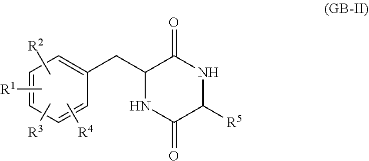

wherein
R¹, R², R³ and R⁴ represent, independently of one another, a hydrogen atom, a hydroxyl group, a (C₁-C₆) alkyl group, a (C₂-C₆) alkenyl group, a (C₂-C₆) acyl group, a (C₂-C₆) acyloxy group, a (C₁-C₆) alkoxy group, an amino group, a (C₂-C₆) acylamino group, a (C₁-C₆) alkylaminocarbonyl group, an aryl group, an aroyl group, an aroyloxy group, an aryloxy group, an aryl-(C₁-C₄) alkyloxy group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, a carboxy-(C₁-C₃) alkyl group, where at least two of the functional groups R¹ to R⁴ can form, together with the remainder of the molecule, a 5-membered or 6-membered ring,
R⁵ represents a hydrogen atom, a linear (C₁ to C₆) alkyl group, a branched (C₃ to C₁₀) alkyl group, a (C₃ to C₆) cycloalkyl group, a (C₂-C₆) alkenyl group, a (C₂-C₆) alkynyl group, a (C₁-C₄) hydroxyalkyl group, a (C₁-C₄) alkoxy-(C₁-C₄) alkyl group, a (C₁-C₄) acyloxy-(C₁-C₄) alkyl group, an aryloxy-(C₁-C₄) alkyl group, an O-(aryl-(C₁-C₄) alkyl)oxy-(C₁-C₄) alkyl group, a (C₁-C₄) alkylsulfanyl-(C₁-C₄) alkyl group, an aryl group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, an N—(C₁-C₄) alkylamino-(C₁-C₄) alkyl group, an N,N—(C₁-C₄) dialkylamino-(C₁-C₄) alkyl group, an N—(C₂-C₈) acylamino-(C₁-C₄) alkyl group, an N—(C₂-C₈) acyl-N—(C₁-C₄) alkylamino-(C₁-C₄) alkyl group, an N—(C₂-C₈) aroyl-N—(C₁-C₄) alkylamino-(C₁-C₄) alkyl group, an N,N—(C₂-C₈) diacylamino-(C₁-C₄) alkyl group, an N-(aryl-(C₁-C₄) alkyl) amino-(C₁-C₄) alkyl group, an N,N-di (aryl-(C₁-C₄) alkyl) amino-(C₁-C₄) alkyl group, a (C₁-C₄) carboxyalkyl group, a (C₁-C₄) alkoxycarbonyl-(C₁-C₃) alkyl group, a (C₁-C₄) acyloxy-(C₁-C₃) alkyl group, a guanidino-(C₁-C₃) alkyl group, an aminocarbonyl (C₁-C₄) alkyl group, an N—(C₁-C₄) alkylaminocarbonyl-(C₁-C₄) alkyl group, an N,N-di ((C₁-C₄) alkyl) aminocarbonyl-(C₁-C₄) alkyl group, an N—(C₂-C₈) acylaminocarbonyl-(C₁-C₄) alkyl group, an N,N—(C₂-C₈) diacylaminocarbonyl-(C₁-C₄) alkyl group, an N—(C₂-C₈) acyl-N—(C₁-C₄) alkylaminocarbonyl-(C₁-C₄) alkyl group, an N-(aryl-(C₁-C₄) alkyl) aminocarbonyl-(C₁-C₄) alkyl group, an N-(aryl-(C₁-C₄) alkyl)-N—(C₁-C₆) alkylaminocarbonyl-(C₁-C₄) alkyl group or an N,N-di (aryl-(C₁-C₄) alkyl) aminocarbonyl-(C₁-C₄) alkyl group.

It is preferred according to the invention if R³ and R⁴ according to formula (GB-II) represent a hydrogen atom. It is particularly preferred according to the invention if R², R³ and R⁴ according to formula (GB-II) represent a hydrogen atom. Therefore, particularly preferred shaped bodies according to the invention contain at least one 2,5-diketopiperazine compound according to formula (GB-IIa)

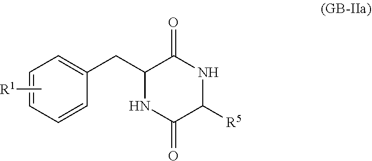

where R¹ and R⁵ are as defined under formula (GB-II) (vide supra).

It has been found to be preferred if the functional group R¹ according to formula (GB-II) and according to formula (GB-IIa) binds in the para position of the phenyl ring. Within the meaning of the present invention, shaped bodies according to the invention are therefore preferred which contain at least one 2,5-diketopiperazine compound according to formula (GB-IIb),

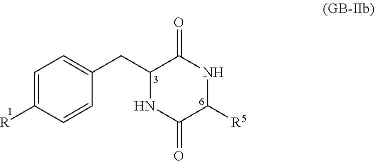

where R¹ and R⁵ are as defined under formula (GB-II) (vide supra). By way of illustration, numbers 3 and 6 positioned at the ring atoms in formula (GB-IIb) only mark positions 3 and 6 of the diketopiperazine ring, as they are generally used in the scope of the invention for naming all 2,5-diketopiperazines according to the invention.

The 2,5-diketopiperazine compounds of formula (GB-II) have centers of chirality at least on the carbon atoms in positions 3 and 6 of the 2,5-diketopiperazine ring. The numbering of ring positions 3 and 6 was illustrated by way of example in formula (GB-IIb). The 2,5-diketopiperazine compound of formula (GB-II) of the composition according to the invention is preferably, based on the stereochemistry of the carbon atoms at the 3 and 6 position of the 2,5-diketopiperazine ring, the configuration isomer 3S,6S, 3R,6S, 3S,6R, 3R,6R, or mixtures thereof, particularly preferably 3S,6S.

Preferred solid gels contain at least one 2,5-diketopiperazine compound of formula (GB-II) as the gelling agent, selected from 3-benzyl-6-carboxyethyl-2,5-diketopiperazine, 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di (benzyl)-2,5-diketopiperazine, 3,6-di (p-hydroxybenzyl)-2,5-diketopiperazine, 3,6-di (p-(benzyloxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine or mixtures thereof. In turn, compounds having the aforementioned configuration isomers are preferably suitable for selection.

It is also possible for the solid gels according to the invention to contain at least one diarylamidocystine compound of formula (GB-III) as the gelling agent a)

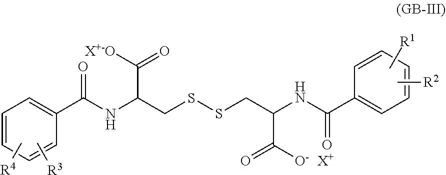

wherein
X⁺ independently represents a hydrogen atom or an equivalent of a cation,
R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, an amino group, an N—(C₁-C₄-alkyl) amino group, an N,N-Di (C₁-C₄-alkyl) amino group, an N—(C₂-C₄-hydroxyalkyl) amino group, an N, N-Di (C₂-C₄-hydroxyalkyl) amino group, or R¹ with R² or R³ with R⁴ forms a 5-membered or 6-membered annulated ring, which in turn can in each case be substituted with at least one group from C₁-C₄ alkyl group, C₁-C₄ alkoxy group, C₂-C₄ hydroxyalkyl group, hydroxyl group, amino group, N—(C₁-C₄-alkyl) amino group, N,N-Di (C₁-C₄-alkyl) amino group, N—(C₂-C₄-hydroxyalkyl) amino group, N,N-Di (C₂-C₄-hydroxyalkyl) amino group.

Each of the stereocenters contained in the compound of formula (GB-III) can represent, independently of one another, the L or D stereoisomer. It is preferable according to the invention for the above-mentioned cystine compound of formula (GB-III) to be derived from the L stereoisomer of cysteine.

The above-mentioned solid gels can contain at least one compound of formula (GB-III), in which R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, or hydroxyl group. In particular, shaped bodies which contain N,N′-dibenzoylcystine (R¹═R²═R³═R⁴=hydrogen atom; X⁺ independently=a hydrogen atom or an equivalent of a cation), in particular N,N′-dibenzoyl-L-cystine, as a diarylamidocystine compound of formula (GB-III) are particularly suitable.

The N—(C₈-C₂₄) hydrocarbylglyconamide compounds suitable as the gelling agent a) preferably have the formula (GB-IV)

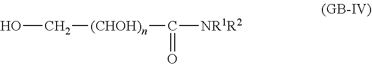

where
n is 2 to 4, preferably 3 or 4, in particular 4;
R¹ is selected from hydrogen, C₁-C₁₆ alkyl groups, C₁-C₃ hydroxy or methoxyalkyl groups, preferably C₁-C₈alkyl, hydroxyalkyl or methoxyalkyl groups, particularly preferably methyl;
R² is selected from C₈-C₂₄ alkyl groups, C₈-C₂₄ monoalkenyl groups, C₈-C₂₄ dialkenyl groups, C₈-C₂₄ trialkenyl groups, C₈-C₂₄ hydroxyalkyl groups, C₈-C₂₄ hydroxyalkenyl groups, C₁-C₃ hydroxyalkyl groups or methoxy-C₁-C₈alkyl groups, preferably C₈-C₁₈ alkyl groups and mixtures thereof, more preferably C₈, C₁₀, C₁₂, C₁₄, C₁₆, and C₁₈ alkyl groups and mixtures thereof, most preferably C₁₂ and C₁₄ alkyl groups or a mixture thereof.

In particularly preferred embodiments, the functional group

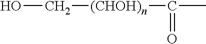

is one of a functional group derived from a glycuronic acid, in particular the glycuronic acid of a hexose (n=4). In particular, glucuronic acid should be mentioned as a preferred functional group. R¹ is preferably H or a short-chain alkyl functional group, in particular methyl. R² is preferably a long-chain alkyl functional group, for example a C₈-C₁₈ alkyl functional group.

Compounds of formula (GB-IV1) are therefore very particularly preferred

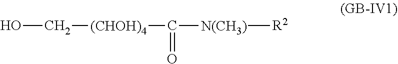

where R² has the meanings given for formula (GB-IV).

In a particularly preferred embodiment, the at least one low-molecular-weight gelling agent of the second free-flowing gelling agent-containing composition is selected from the group consisting of the group of cyclic dipeptides, cyclic dipeptide derivatives and dibenzylidene sorbitols. The at least one gelling agent of the second free-flowing gelling agent-containing composition is more particularly preferably dibenzylidene sorbitol (DBS) because of its technical effect.

In step iii) of the method, the first and second free-flowing compositions are fed to the dynamic mixer. In one embodiment of the method, the first and second free-flowing compositions are fed to the mold in the same line. This procedure is characterized by a reduced level of apparatus. In this procedure, the first and second free-flowing compositions can be mixed proportionally already in the feed line leading to the mold. The disadvantages of this procedure are reduced control of the gelling process and, in the event of an interruption in production, increased cleaning effort before the manufacturing apparatus is restarted.

For the latter reasons, it is preferable to feed the first free-flowing composition and the second free-flowing composition to the dynamic mixer in separate lines.

The procedure according to the invention is particularly suitable for processes in the course of which free-flowing compositions are mixed in widely differing weight proportions. Thus, in the method according to the invention, the first free-flowing composition and the second free-flowing composition are preferably mixed in a weight ratio of 50:1 to 5:1, preferably 35:1 to 8:1.

For mixing, but also for further transfer to the shaping device, it has proven advantageous if the free-flowing compositions in the dynamic mixer are subjected to a shear rate of 50 to 5000 s−1, preferably 80 to 2000 s−1 and in particular 100 to 1200 s−1.

The dynamic mixer is preferably selected from the group of rotor-stator mixers. Static-dynamic mixers are particularly preferred.

When it exits the dynamic mixer, the surfactant-containing and gelling agent-containing mixture preferably has a temperature above 23° C., particularly preferably a temperature in the range of 23° C. to 60° C.

The time period between the exit of the surfactant-containing and gelling agent-containing mixture from the dynamic mixer and its entry into the shaping device is preferably 1 to 20 seconds, particularly preferably 1 to 10 seconds.

A number of different devices are suitable as shaping devices, for example a rotating shaping roller, an extruder or a casting mold.

When a shaping roller is used, the mixture is pressed into the indentations of the shaping roller by means of a pressure roller and shaped. Excess material can be removed using a scraper, for example. An extraction belt can be used to remove material from the indentations in the shaping roller.

In an extruder, the mixture is continuously pressed out of a shaping opening under pressure. The resulting extruded strand is cut to a suitable length to form individual shaped bodies.

A casting mold is particularly preferably used as the shaping device. The materials known to a person skilled in the art for the manufacture of casting molds, for example materials from the group of metals, polymers or rubbers, are suitable for manufacturing the casting mold. With regard to removing the solid gel from the mold, materials from the group of silicones have proven to be particularly suitable.

In step iv) of the method, the mixture is introduced into the shaping device, for example the casting mold. In a preferred embodiment of the method, the surfactant-containing and gelling agent-containing mixture is introduced into the casting mold by means of an injector.

The surfactant-containing and gelling agent-containing mixture is preferably introduced into the casting mold at a filling rate of 1 ml/s to 25 ml/s.

To avoid contamination around the casting mold, in particular in its edge region, it has proven advantageous to lower the injector into the casting mold before introducing the surfactant-containing and gelling agent-containing mixture. The outlet opening of the injector is preferably located above the volume center of the mold.

The injector and the casting mold can be moved relative to one another to support the filling of the casting mold with the surfactant-containing and gelling agent-containing mixture in step v). Such a relative movement can be achieved by moving the injector, moving the mold or moving the injector and mold.

A preferred method variant that is technically easy to implement provides for the injector to be moved in the mold in step v). The movement can take place in the mold in a horizontal or vertical or horizontal and vertical direction. In the case of horizontal movement, the direction of movement of the injector is parallel to the opening surface of the mold; in the case of vertical movement, the direction of movement is orthogonal to this surface.

Alternatively or in conjunction with the movement of the mixing element, the mold can be moved in step v). A corresponding relative movement can result, for example, from the transportation of the mold on a conveyor belt or from a vibrating movement of the mold. The mold can also be moved in a horizontal or vertical or horizontal and vertical direction. In the case of horizontal movement, the direction of movement of the mold is parallel to its opening surface; in the case of vertical movement, the direction of movement is orthogonal to this surface.

In step vi) of the method, the surfactant-containing and gelling agent-containing mixture solidifies such that a dimensionally stable solid gel is formed. To accelerate the solidification process, the surfactant-containing and gelling agent-containing mixture can be cooled in step vi). The cooling preferably takes place under defined climatic conditions in which, in addition to the temperature, the humidity in the process chamber is also controlled and regulated, for example.

Finally, the dimensionally stable solid gel can be removed from the mold.

In order to manufacture detergent portion units which comprise further components in addition to the solid gel, a procedure is suitable in which the solid gel is bonded to a prefabricated shaped body.

In a first preferred procedure, the previously described casting mold is proportionally filled with a prefabricated shaped body. The prefabricated shaped body covers the bottom surface of the mold into which the first and second free-flowing preparations are introduced in step iv), preferably at least partially, particularly preferably completely.

In an alternative or, in conjunction with the procedure described above, second preferred procedure, the surfactant-containing and gelling agent-containing mixture is covered with a prefabricated shaped body before, during or after solidification in step vi) in the mold. In this case, it is preferred that the surface of the surfactant-containing and gelling agent-containing mixture visible in the mold is completely covered with a prefabricated shaped body.

If the surfactant-containing and gelling agent-containing mixture is introduced in the mold onto a first prefabricated shaped body and the side opposite the side covered with the first prefabricated shaped body is covered with a second prefabricated shaped body, a sandwich-like detergent portion unit, which is particularly advantageous in terms of handling and optics, is obtained.

A particularly preferred method variant for manufacturing a detergent portion unit, comprising
a) a dimensionally stable solid gel
b) two shaped bodies
comprises the steps of:
   i) providing a first free-flowing surfactant-containing composition;
   ii) providing a second free-flowing gelling agent-containing composition that is different from the first free-flowing composition;
   iii) continuously feeding the first and second free-flowing compositions to a dynamic mixer;
   iv) mixing the first and second free-flowing compositions by means of the dynamic mixer such that a surfactant-containing and gelling agent-containing mixture is formed;
   v) introducing the surfactant-containing and gelling agent-containing mixture into a casting mold whose bottom surface is at least proportionally covered with a first prefabricated shaped body;
   vi) covering, with a second prefabricated shaped body, the side of the surfactant-containing and gelling agent-containing mixture opposite to the side covered by the first prefabricated shaped body;
   vii) letting the surfactant-containing and gelling agent-containing mixture solidify such that a dimensionally stable solid gel is formed.
   viii) demolding the solid gel such that a detergent portion unit comprising a solid gel and the first and second prefabricated shaped bodies is formed.

Preferred shaped bodies fill 5 to 45 vol. %, preferably 10 to 25 vol. % of the mold.

The shaped body can be packaged in different ways. The use of casting bodies has proven to be technically easy to implement. The manufacture of the shaped body using casting processes has the advantage that a wide variety of geometries can be produced. The casting bodies are particularly preferably solidified melts.

Due to their ease of manufacture on an industrial scale, extruded bodies, in particular tablets, are particularly preferred as shaped bodies.

Irrespective of the method used for its manufacture, the shaped body preferably has a breaking strength of 50 N to 300 N, in particular of 50 N to 150 N. This breaking strength ensures, on the one hand, that the shaped body is sufficiently stable during production, transport and handling by the consumer and, on the other hand, ensures a satisfactory dissolution behavior of the shaped body in an aqueous liquor. The hardness of the shaped body is measured by deformation until fracture, wherein the force acting on the side surfaces of the shaped body and the maximum force that it withstands is determined. In order to determine the level of shaped body hardness, a tablet testing apparatus from the company Sotax is suitable, for example.

Preferred shaped bodies have an imprint.

If the solid gel is combined with a shaped body as described above, the dimensionally stable solid gel, which is proportionally covered by a shaped body, is finally removed from the mold. The solid gel and the shaped body are preferably adhesively bonded to one another.

In a preferred embodiment of the detergent portion units, the shaped body also contributes to the active washing and active cleaning effect. Corresponding detergent portion units comprise a shaped body which, based on its total weight, contains more than 40 wt. %, preferably more than 60 wt. %, particularly preferably more than 80 wt. %, of active washing or active cleaning ingredient.

Fragrances form a first group of active washing or active cleaning ingredients integrated in the shaped body. Their incorporation into the shaped body ensures a fragrance experience that can be perceived by the consumer and which cannot be ensured in the same way when the fragrances are incorporated into the solid gel.

Builders constitute a further group of active washing or active cleaning ingredients preferably incorporated in the casing substance, in particular the citrates, the zeolites, silicates, and carbonates, particularly preferably in particular the citrates and the zeolites. The proportion by weight of said active ingredients with respect to the total weight of the casing substance is preferably 5 to 60 wt. %, in particular 10 to 50 wt. %. Casing substances which contain, based on the total weight thereof, 5 to 60 wt. %, in particular 10 to 50 wt. % of citrate and/or zeolite are particularly preferred. These active substances not only contribute to the washing and cleaning effect as intended, but also improve the contour sharpness and resistance of the imprinted image in the event of the shaped body surface being imprinted.

The use of an active substance from the group of polymeric active washing or active cleaning ingredients, preferably from the group of celluloses and cellulose derivatives, and anionic or nonionic aromatic polyesters, preferably from the group of celluloses, microcrystalline celluloses and carboxymethyl celluloses and of anionic or nonionic aromatic polyesters, is also advantageous for the contour sharpness and resistance of the imprinted image. The proportion by weight of said cellulose-based active ingredients with respect to the total weight of the casing substance is preferably 2 to 50 wt. %.

The composition of some preferred detergent portion units can be found in the following tables (amounts given in wt. % based on the total weight of the solid gel or the casing substance, unless otherwise indicated).

| Formula | Formula | Formula | Formula |
|---|---|---|---|
| 1 | 2 | 3 | 4 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Shaped body

| Builder from the | 5 to 90 | 50 to 90 | 50 to 80 | 50 to 80 |
|---|---|---|---|---|
| group of citrates, | | | | |
| zeolites, silicates, | | | | |
| and carbonates | | | | |
| | Formula | Formula | Formula | Formula |
| | 6 | 7 | 8 | 9 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| Builder from the | 5 to 90 | 50 to 90 | 50 to 80 | 50 to 80 |
|---|---|---|---|---|
| group of citrates, | | | | |
| zeolites, silicates, | | | | |
| and carbonates | | | | |
| Cellulose and | 0.5 to 10 | 1.0 to 8.0 | 1.0 to 5.0 | 1.0 to 5.0 |
| cellulose derivatives | | | | |
| | Formula | Formula | Formula | Formula |
| | 11 | 12 | 13 | 14 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| Builder from the | 10 to 70 | 20 to 60 | 20 to 60 | 30 to 50 |
|---|---|---|---|---|
| group of citrates | | | | |
| and zeolites | | | | |
| | Formula | Formula | Formula | Formula |
| | 15 | 16 | 17 | 18 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from the | 10 to 70 | 20 to 60 | 20 to 60 | 30 to 50 |
| group of citrates | | | | |
| and zeolites | | | | |
| Cellulose and | 0.5 to 10 | 1.0 to 8.0 | 1.0 to 5.0 | 1.0 to 5.0 |
| cellulose derivatives | | | | |

In summary, the following subjects, inter alia, are provided by this application:

1. A method for manufacturing a detergent portion unit, comprising
a) a dimensionally stable solid gel, the method comprising the steps of:
   i) providing a first free-flowing surfactant-containing composition;
   ii) providing a second free-flowing gelling agent-containing composition that is different from the first free-flowing composition;
   iii) continuously feeding the first and second free-flowing compositions to a dynamic mixer;
   iv) mixing the first and second free-flowing compositions by means of the dynamic mixer such that a surfactant-containing and gelling agent-containing mixture is formed;
   v) introducing the surfactant-containing and gelling agent-containing mixture into a shaping device;
   vi) letting the surfactant-containing and gelling agent-containing mixture solidify such that a dimensionally stable solid gel is formed.

2. The method according to point 1, wherein the solid gel has a weight of from 14 g to 42 g, preferably of from 18 g to 38 g and in particular of from 20 g to 34 g.

3. The method according to one of the preceding points, wherein the solid gel comprises a flat underside, the largest diagonal of which is greater than the height of the solid gel.

4. The method according to one of the preceding points, wherein the solid gel has a flat underside, the largest diagonal of which is more than 1.5 times, preferably more than twice the height of the solid gel.

5. The method according to one of the preceding points, wherein the solid gel has an oval underside.

6. The method according to one of the preceding points, wherein the solid gel has an ellipsoidal or round, preferably a round underside.

7. The method according to one of the preceding points, wherein the solid gel has an angular underside, preferably an angular underside with rounded corners.

8. The method according to one of the preceding points, wherein the solid gel has a triangular, square or hexagonal underside.

9. The method according to one of the preceding points, wherein the solid gel has an upper side plane-parallel to the underside.

10. The method according to one of the preceding points, wherein the solid gel has an underside and an upper side which have the same geometric shape, wherein the underside and the upper side have the same surface size.

11. The method according to one of the preceding points, wherein the solid gel has an underside and an upper side which have the same geometric shape, and wherein the underside and the upper side have different surface sizes.

12. The method according to one of the preceding points, wherein the solid gel has an underside and an upper side which are connected to one another by a cylindrical lateral surface.

13. The method according to one of the preceding points, wherein the solid gel has an underside and an upper side and the area of the upper side is 80 to 100%, preferably 90 to 100% and in particular 98 to 100% of the underside.

14. The method according to one of the preceding points, wherein the first free-flowing surfactant-containing composition contains, based on the total weight thereof, 30 to 70 wt. %, preferably 40 to 60 wt. % and in particular 45 to 55 wt. %, surfactant.

15. The method according to one of the preceding points, wherein the dimensionally stable solid gel contains, based on the total weight thereof, 15 to 35 wt. %, preferably 20 to 30 wt. %, aqueous-organic solvent.

16. The method according to one of the preceding points, wherein the second free-flowing gelling agent-containing composition contains low-molecular-weight gelling agents having a molar mass of up to 2000 g/mol, wherein the proportion by weight thereof with respect to the total weight of the solid gel is preferably less than 5 wt. %, preferably 0.1 to 5 wt. %, particularly preferably 0.1 to 2.5 wt. %.

17. The method according to one of the preceding points, wherein the second free-flowing gelling agent-containing composition contains low-molecular-weight gelling agents selected from the group of cyclic dipeptides, the cyclic dipeptide derivatives and dibenzylidene sorbitols.

18. The method according to one of the preceding points, wherein the second free-flowing gelling agent-containing composition contains dibenzylidene sorbitol as a low-molecular-weight gelling agent.

19. The method according to one of the preceding points, wherein the second free-flowing gelling agent-containing composition further contains an organic solvent.

20. The method according to one of the preceding points, wherein the second free-flowing gelling agent-containing composition contains gelling agents and organic solvents in a total weight proportion above 50 wt. %, preferably above 70 wt. % and in particular above 90 wt. %.

21. The method according to one of the preceding points, wherein the first and second free-flowing compositions are fed to the dynamic mixer in separate lines.

22. The method according to one of the preceding points, wherein the first and second free-flowing compositions are mixed in a weight ratio of from 50:1 to 5:1, preferably from 35:1 to 8:1.

23. The method according to one of the preceding points, wherein the free-flowing compositions are subjected to a shear rate of from 50 to 5000 s−1, preferably from 80 to 2000 s−1 and in particular from 100 to 1200 s−1 in the dynamic mixer.

24. The method according to one of the preceding points, wherein the dynamic mixer selected from the group of rotor-stator mixers.

25. The method according to one of the preceding points, wherein dynamic mixer selected from the group of static-dynamic mixers.

26. The method according to one of the preceding points, wherein the surfactant-containing and gelling agent-containing mixture has a temperature above 23° C., preferably in the range of 23° C. to 60° C., on exiting the dynamic mixer.

27. The method according to one of the preceding points, wherein the time period between the exit of the surfactant-containing and gelling agent-containing mixture from the dynamic mixer and its entry into the shaping device is 1 to 20 seconds, preferably 1 to 10 seconds.

28. The method according to one of the preceding points, wherein a rotating shaping roller is used as the shaping device.

29. The method according to one of points 1 to 27, wherein an extruder is used as the shaping device.

30. The method according to one of points 1 to 27, wherein a casting mold is used as the shaping device.

31. The method according to point 30, wherein the casting mold is made of a material selected from the group consisting of metals, polymers or rubbers.

32. The method according to point 31, wherein the casting mold is made of a material from the group of silicones.

33. The method according to one of points 30 to 32, wherein the surfactant-containing and gelling agent-containing mixture is introduced into the casting mold by means of an injector.

34. The method according to one of points 30 to 33, wherein the surfactant-containing and gelling agent-containing mixture is introduced into the casting mold at a filling rate of 1 ml/s to 25 ml/s.

35. The method according to one of points 30 to 34, wherein the injector is lowered into the casting mold before the surfactant-containing and gelling agent-containing mixture is introduced.

36. The method according to one of points 30 to 35, wherein the outlet opening of the injector is located above the volume center of the mold.

37. The method according to one of points 30 to 36, wherein the surfactant-containing and gelling agent-containing mixture is filled into a casting mold in step v) by means of an injector and the injector and the casting mold are simultaneously moved relative to one another.

38. The method according to point 37, wherein the injector and the casting mold are moved horizontally relative to one another.

39. The method according to one of the preceding points, wherein the surfactant-containing and gelling agent-containing mixture is cooled in step vi).

40. The method according to one of the preceding points, wherein the dimensionally stable solid gel is removed from the mold following step vi).

41. The method according to one of points 30 to 40, wherein the casting mold is proportionally filled with a prefabricated shaped body.

42. The method according to point 41, wherein the bottom surface of the mold into which the surfactant-containing and gelling agent-containing mixture is introduced in step iv) is at least proportionally, preferably completely, covered with a prefabricated shaped body.

43. The method according to one of the preceding points, wherein the surfactant-containing and gelling agent-containing mixture is covered with a prefabricated shaped body before, during or after solidification in step vi).

44. The method according to one of the preceding points, wherein the surface of the surfactant-containing and gelling agent-containing mixture is completely covered with a prefabricated shaped body.

45. The method according to one of points 41 to 44, wherein the prefabricated shaped body fills 5 to 45 vol. %, preferably 10 to 25 vol. % of the mold.

46. The method according to one of points 41 to 45, wherein the shaped body is present as a casting body.

47. The method according to one of points 41 to 46, wherein the shaped body is present as an extruded body, preferably as a tablet.

48. The method according to one of points 41 to 47, wherein the shaped body has a breaking strength of 30 N to 300 N, preferably of 50 N to 150 N.

49. The method according to one of points 41 to 48, wherein the shaped body has an imprint.

50. The method according to one of points 41 to 49, wherein the dimensionally stable solid gel proportionally covered by a shaped body is removed from the mold following step vi).

51. The method according to one of points 41 to 50, wherein the shaped body contains, based on its total weight, more than 40 wt. %, preferably more than 60 wt. %, particularly preferably more than 80 wt. %, active washing or active cleaning ingredient.

52. The method according to one of points 41 to 51, wherein the shaped body contains an active washing or active cleaning ingredient from the group of fragrances.

53. The method according to one of points 41 to 52, wherein the shaped body contains an active washing or active cleaning ingredient from the group of builders, in particular at least one active substance from the group of citrates, zeolites, silicates, and carbonates, preferably from the group of citrates and zeolites.

54. The method according to one of points 41 to 53, wherein the shaped body contains a polymeric active washing or active cleaning ingredient, preferably polymeric active washing or active cleaning ingredients from the group of celluloses and cellulose derivatives, and of the anionic or nonionic aromatic polyesters, preferably from the group of celluloses, microcrystalline celluloses, and carboxymethyl celluloses, and of the anionic or nonionic aromatic polyesters.

55. The method according to one of points 41 to 54, wherein the solid gel and the shaped body are adhesively bonded to one another.

1. A method for manufacturing a detergent portion unit comprising a dimensionally stable solid gel, the method comprising:
mixing a first free-flowing surfactant-containing composition and a second free-flowing gelling agent-containing composition that is different from the first free-flowing surfactant-containing composition using a dynamic mixer such that a surfactant-containing and gelling agent-containing mixture is formed;
introducing the surfactant-containing and gelling agent-containing mixture into a shaping device; and
maintaining the surfactant-containing and gelling agent-containing mixture in the shaping device to solidify such that a dimensionally stable solid gel is formed.

2. The method of claim 1, wherein the dimensionally stable solid gel has a weight of from 14 g to 42 g.

3. The method of claim 1, wherein the first free-flowing surfactant-containing composition comprises a surfactant in an amount of from 30 to 70 wt. %.

4. The method of claim 1, wherein the second free-flowing gelling agent-containing composition comprises a low-molecular-weight gelling agent having a molar mass of up to 2000 g/mol, wherein the low-molecular-weight gelling agent is in an amount of from 0.1 to 5 wt. % based on the total weight of the second free-flowing gelling agent-containing composition.

5. The method of claim 4, wherein the low-molecular-weight gelling agent comprises dibenzylidene sorbitol.

6. The method of claim 1, wherein the first free-flowing surfactant-containing composition and the second free-flowing gelling agent-containing composition are fed to the dynamic mixer using separate lines.

7. The method of claim 1, wherein the first free-flowing surfactant-containing composition and the second free-flowing gelling agent-containing composition have a weight ratio of from 50:1 to 5:1 in the shaping device.

8. The method of claim 1, wherein the surfactant-containing and gelling agent-containing mixture is introduced from the dynamic mixer and into the shaping device in a time period of from 1 to 20 seconds.

9. The method of claim 1, wherein the shaping device is a rotating shaping roller.

10. The method of claim 1, wherein the shaping device is an extruder.

11. The method of claim 2, wherein the dimensionally stable solid gel has a weight of from 18 g to 38 g.

12. The method of claim 11, wherein the dimensionally stable solid gel has a weight of from 20 g to 34 g.

13. The method of claim 3, wherein the first free-flowing surfactant-containing composition comprises a surfactant in an amount of from 40 to 60 wt. % based on the total weight of the first free-flowing surfactant-containing composition.

14. The method of claim 13, wherein the first free-flowing surfactant-containing composition comprises a surfactant in an amount of from 45 to 55 wt. % based on the total weight of the first free-flowing surfactant-containing composition.

15. The method of claim 4, wherein the low-molecular-weight gelling agent is in an amount of from 0.1 to 2.5 wt. % based on the total weight of the second free-flowing gelling agent-containing composition.

16. The method of claim 7, wherein the first free-flowing surfactant-containing composition and the second free-flowing gelling agent-containing composition have a weight ratio of from 35:1 to 8:1 in the shaping device.

17. The method of claim 8, wherein the surfactant-containing and gelling agent-containing mixture is introduced from the dynamic mixer and into the shaping device in a time period of from 1 to 10 seconds.

18. The method of claim 1, wherein the surfactant-containing and gelling agent-containing mixture is introduced from the dynamic mixer and into the shaping device at a temperature of from 23° C. to 60° C.

19. The method of claim 1, wherein the dimensionally stable solid gel comprises an organic solvent.

20. The method of claim 1, wherein the detergent portion unit further comprises a polymeric active washing or active cleaning ingredient.
